(19) United States
(12) Patent Application Publication
(10) Pub. No.: US 2006/0052468 A1
(43) Pub. Date: Mar. 9, 2006

(54) Resin composition for use in a froth spraying system

(76) Inventors: Chris Janzen, Toronto (CA); Greg Gardin, Cambridge (CA); Pierre Couture, Ste-Martine (CA)

Correspondence Address: BASF AKTIENGESELLSCHAFT, CARL-BOSCH STRASSE 38, 67056 LUDWIGSHAFEN, LUDWIGSHAFEN, 69056, DE

(21) Appl. No.: 10/936,299

(22) Filed: Sep. 8, 2004

(51) Int. Cl. C08J 9/00; C08G 18/48; C09K 3/00

(52) U.S. Cl. 521/130; 521/131; 252/182.24

(57) ABSTRACT

A resin composition for use in a froth spraying system for forming polyurethane foam is disclosed. The resin composition comprises a Mannich polyol, at least one additional polyol other than a Mannich polyol, and a physical blowing agent. The Mannich polyol has a viscosity of at least 4,000 centipoise at 25° C. The physical blowing agent is selected from the group of volatile non-halogenated C₂ to C₇ hydrocarbons, hydrofluorocarbons, hydrochlorocarbons, and mixtures thereof. The physical blowing agent is present in an amount of greater than 10 parts by weight based on 100 parts by weight of the resin composition. A method of forming the polyurethane foam is also provided comprising the steps of providing the resin composition and a polyisocyanate, mixing the resin composition with the polyisocyanate in a mixing chamber to form a mixture, and discharging the mixture from a dispensing gun as the resin composition reacts with the polyisocyanate to form the polyurethane foam.

### BACKGROUND OF THE INVENTION

1. Field of the Invention

The subject invention relates to a resin composition for use in a froth spraying system for forming polyurethane foam.

2. Description of the Related Art

Various hydrofluorocarbons (HFC's) have been investigated in the industry as blowing agents for polyisocyanate based foams due to their low or nonexistent ozone depletion potentials. Such a system would allow for production of an environmentally friendly closed cell polyurethane foam that exhibits improved cell structure and expands at a lower temperature range. These related art systems use a resin composition that includes a Mannich polyol, at least one additional polyol other than a Mannich polyol, and chemical blowing agents. The chemical blowing agents increase the cost of preparing the polyurethane foam because the chemical blowing agents react with the polyisocyanate. Therefore, additional polyisocyanate is required to form the polyurethane foam that increases the cost of producing the polyurethane foam.

Other related art systems have used, in addition to the chemical blowing agent, lower amounts of a physical blowing agent. The physical blowing agent is typically selected from hydrocarbons, hydrofluorocarbons, hydrochlorocarbons, and mixtures thereof. One such example is disclosed in U.S. Pat. No. 6,534,556 assigned to the assignee of the subject invention. The '556 patent uses no more than 10 parts by weight of the physical blowing agent because the resin composition becomes saturated and additional physical blowing agent can not be added. This is particularly true when the physical blowing agent is R-134a. Additionally, using an amount of 10 parts by weight or less of the physical blowing agent reduces the cost of producing the polyurethane foam.

### BRIEF SUMMARY OF THE INVENTION AND ADVANTAGES

The subject invention provides a resin composition for use in a froth spraying system for forming polyurethane foam. The resin composition comprises a Mannich polyol, at least one additional polyol other than a Mannich polyol, and a physical blowing agent. The Mannich polyol has a viscosity of at least 4,000 centipoise at 25° C. The physical blowing agent is selected from the group of volatile non-halogenated C₂ to C₇ hydrocarbons, hydrofluorocarbons, hydrochlorocarbons, and mixtures thereof. The physical blowing agent is present in an amount of greater than 10 parts by weight based on 100 parts by weight of the resin composition.

The subject invention further provides a method of forming the polyurethane foam using the froth spraying system. The froth spraying system generally includes supply vessels, a spray machine, and a dispensing gun having a mixing chamber. The method provides the resin composition and a polyisocyanate and mixes the resin composition with the polyisocyanate in the mixing chamber to form a mixture. The mixture is discharged from the dispensing gun as the resin composition reacts with the polyisocyanate to form the polyurethane foam.

The subject invention provides a spray froth system that allows for improved delivery of a resin composition and a polyisocyanate. The spray froth system allows the resin composition to have increased amounts of physical blowing agents that have not been previously utilized advantageously. The polyurethane foam produced with such a system achieves the desired physical properties and characteristics.

### DETAILED DESCRIPTION OF THE INVENTION

A froth spraying system mixes a resin composition and a polyisocyanate to form a mixture and the mixture is dispensed from a dispensing gun to form a polyurethane foam. A first stream carries the resin composition from a storage tank or a pressurized vessel to the dispensing gun. A second stream, separate from the first stream, carries the polyisocyanate from a storage tank or a pressurized vessel to the dispensing gun. The two streams are mixed together in a mixing chamber of the dispensing gun and begin to react. As the mixture continues to react, it is dispensed from the dispensing gun onto or in the direction of a substrate. In one embodiment, the substrate may include a wall having cavities therein for receiving the mixture. Other embodiments of the substrate may include pipes or any other equipment that requires insulation. Typically, upon completing the reaction, the polyurethane foam acts as an insulation for the substrate.

The resin composition includes a physical blowing agent that causes the mixture to froth as the mixture exits the dispensing gun. However, those skilled in the art recognize that the mixture may not necessarily froth as it is dispensed from the dispensing gun. Those skilled in the art recognize that the physical blowing agent sufficiently and spontaneously vaporizes when the two combined streams are exposed to atmospheric pressure upon discharge. The vaporization of the physical blowing agent produces the froth. It is to be understood that not all of the physical blowing agent needs to vaporize instantaneously when discharged, but at least an amount sufficient to produce the froth should vaporize upon discharge from the dispensing gun.

The resin composition, in addition to the physical blowing agent, includes a Mannich polyol and at least one additional polyol other than the Mannich polyol. The resin composition may also include a catalyst system, surfactants, flame retardants, fillers, stabilizers, fungicides, pigments or dyes and bacteriostats. The resin composition is substantially free of chemical blowing agents. Chemical blowing agents include any blowing agents that chemically react with the resin composition or the polyisocyanate, such as, but not limited to, water. It is to be understood that, in the context of the subject invention, substantially free of chemical blowing agents is intended to indicate that the resin composition has less than 5 parts by weight, preferably less than 2.5 parts by weight, and most preferably less than 1.5 parts by weight, based on 100 parts by weight of the resin composition.

The Mannich polyol is made by alkoxylating a Mannich compound, which is the condensation product of phenol or a substituted phenol, formaldehyde, and an alkanoamine, such as diethanol amine. For example, the Mannich reaction is conducted by premixing the phenolic compound with a desired amount of the ethanolamine and then slowly adding formaldehyde to the mixture at a temperature below the temperature of Novolak formation. At the end of the reaction, water is stripped from the reaction mixture to provide a crude Mannich reaction product.

The Mannich reaction product is then alkoxylated with an alkylene oxide such as, for example, propylene oxide, ethylene oxide, or a mixture of propylene oxide and ethylene oxide. The alkylene oxide may suitably comprise from about 80 to 100 parts by weight propylene oxide and from 0 to about 20 parts by weight ethylene oxide based on 100 parts by weight of the alkylene oxide. Alkoxylation of Mannich reaction products is described in U.S. Pat. Nos. 3,297,597 and 4,137,265, the disclosures of which are incorporated herein by reference.

The alkoxylation with propylene oxide is carried out by introducing the propylene oxide, preferably under pressure, into a vessel containing the Mannich reaction product. No added catalyst is needed since the basic nitrogen in this product provides sufficient catalytic activity to promote the reaction. Reaction temperatures between about 30° C. and about 200° C. may be employed, but the preferred reaction temperatures are in the range of from about 90° to 120° C. Under these conditions, the phenolic hydroxyl group and the alkanolamino hydroxyls are reactive to form hydroxypropyl groups. Unreacted and partially reacted materials are removed from the final condensation product in any suitable manner (e.g., by vacuum stripping) to provide clear amber to brown liquids having hydroxyl numbers in the range of 400 to 550 and viscosities between about 4,000 and 45,000 centipoises at 25° C. The Mannich polyol preferably having a viscosity of at least 4,000 centipoise at 25° C.

In a preferred embodiment of the present invention, the Mannich polyol is present in the resin composition in an amount of from 20 to 40 parts by weight based on 100 parts by weight of the resin composition. Preferably, the resin composition has a hydroxyl content of at least 400 mg KOH/g. Additionally, the Mannich polyol preferably comprises an aromatic, amine polyol having a hydroxyl content of at least 400 mg KOH/g. The aromatic, amine polyol preferably has an amino content of at least 2.8 meq/g.

The resin composition also includes at least one additional polyol compound having at least two isocyanate-reactive hydrogens. The compounds having at least two isocyanate-reactive hydrogens preferably have an average hydroxyl number ranging from 150 to 800 mg KOH/g of compound.

Examples of these polyols include polythioether polyols, polyester amides and polyacetals containing hydroxyl groups, aliphatic polycarbonates containing hydroxyl groups, amine-terminated polyoxyalkylene polyethers, polyester polyols, and polyoxyalkylene polyether polyols. In addition, mixtures of at least two of the aforesaid polyols can be used.

The term “polyester polyol” as used in this specification and claims includes any minor amounts of unreacted polyol remaining after the preparation of the polyester polyol and/or unesterified polyol (e.g., glycol) added after the preparation of the polyester polyol. The polyester polyol can include up to about 40 weight percent free glycol.

Suitable polyester polyols can be produced, for example, from organic dicarboxylic acids with 2 to 12 carbons, preferably aliphatic dicarboxylic acids with 4 to 6 carbons, and multivalent alcohols, preferably diols, with 2 to 12 carbons, preferably 2 to 6 carbons. Examples of dicarboxylic acids include succinic acid, glutaric acid, adipic acid, suberic acid, azelaic acid, sebacic acid, decanedicarboxylic acid, maleic acid, fumaric acid, phthalic acid, isophthalic acid and terephthalic acid. The dicarboxylic acids can be used individually or in mixtures. Instead of the free dicarboxylic acids, the corresponding dicarboxylic acid derivatives may also be used such as dicarboxylic acid mono- or di- esters of alcohols with 1 to 4 carbons, or dicarboxylic acid anhydrides. Dicarboxylic acid mixtures of succinic acid, glutaric acid and adipic acid in quantity ratios of 20-35:35-50:20-32 parts by weight are preferred, especially adipic acid. Examples of divalent and multivalent alcohols, especially diols, include ethanediol, diethylene glycol, 1,2- and 1,3-propanediol, dipropylene glycol, 1,4-butanediol, 1,5-pentanediol, 1,6-hexanediol, 1,10-decanediol, glycerine and trimethylolpropanes, tripropylene glycol, tetraethylene glycol, tetrapropylene glycol, tetramethylene glycol, 1,4-cyclohexane-dimethanol, or mixtures of at least two of these diols are preferred, especially mixtures of 1,4-butanediol, 1,5-pentanediol and 1,6-hexanediol. Furthermore, polyester polyols of lactones, e.g., ε-caprolactone or hydroxycarboxylic acids, e.g., ω-hydroxycaproic acid, may also be used.

The polyester polyols can be produced by polycondensation of organic polycarboxylic acids, e.g., aromatic or preferably aliphatic polycarboxylic acids and/or derivatives thereof and multivalent alcohols in the absence of catalysts or preferably in an atmosphere of an inert gas, e.g., nitrogen, carbon dioxide, helium, argon, etc., in the melt at temperatures of 150° to 250° C., preferably 180° to 220° C., optionally under reduced pressure, up to the desired acid value which is preferably less than 10, especially less than 2. In a preferred embodiment, the esterification mixture is subjected to polycondensation at the temperatures mentioned above up to an acid value of 30 to 80, preferably 30 to 40, under normal pressure, and then under a pressure of less than 500 mbar, preferably 50 to 150 mbar. The reaction can be carried out as a batch process or as a continuous process. When present, excess glycol can be distilled from the reaction mixture during and/or after the reaction, such as in the preparation of low free glycol-containing polyester polyols usable in the present invention. Examples of suitable esterification catalysts include iron, cadmium, cobalt, lead, zinc, antimony, magnesium, titanium and tin catalysts in the form of metals, metal oxides or metal salts. However, the polycondensation may also be preformed in liquid phase in the presence of diluents and/or chlorobenzene for aziotropic distillation of the water of condensation.

To produce the polyester polyols, the organic polycarboxylic acids and/or derivatives thereof and multi-valent alcohols are preferably polycondensed in a mole ratio of 1:1-1.8, more preferably 1:1.05-1.2.

After transesterification or esterification, the reaction product can be reacted with an alkylene oxide to form a polyester polyol mixture. This reaction desirably is catalyzed. The temperature of this process should be from about 80° to 170° C., and the pressure should generally range from about 1 to 40 atmospheres.

While the aromatic polyester polyols can be prepared from substantially pure reactant materials, more complex ingredients can be used, such as the side stream, waste or scrap residues from the manufacture of phthalic acid, terephthalic acid, dimethyl terephthalate, polyethylene terephthalate, and the like. Compositions containing phthalic acid residues for use in the invention are (a) ester-containing byproducts from the manufacture of dimethyl terephthalate, (b) scrap polyalkylene terephthalates, (c) phthalic anhydride, (d) residues from the manufacture of phthalic acid or phthalic anhydride, (e) terephthalic acid, (f) residues from the manufacture of terephthalic acid, (g) isophthalic acid, (h) trimellitic anhydride, and (i) combinations thereof. These compositions may be converted by reaction with the polyols of the invention to polyester polyols through conventional transesterification or esterification procedures.

Other materials containing phthalic acid residues are polyalkylene terephthalates, especially polyethylene terephthalate (PET), residues or scraps. Still other residues are dimethyl terephthalate (DMT) process residues, which are waste or scrap residues from the manufacture of DMT. The term “DMT process residue” refers to the purged residue which is obtained during the manufacture of DMT in which p-xylene is converted through oxidation and esterification with methanol to the desired product in a reaction mixture along with a complex mixture of byproducts. The desired DMT and the volatile methyl p-toluate byproduct are removed from the reaction mixture by distillation leaving a residue. The DMT and methyl p-toluate are separated, the DMT is recovered and methyl p-toluate is recycled for oxidation. The residue which remains can be directly purged from the process or a portion of the residue can be recycled for oxidation and the remainder diverted from the process or, if desired, the residue can be processed further as, for example, by distillation, heat treatment and/or methanolysis to recover useful constituents which might otherwise be lost, prior to purging the residue from the system. The residue which is finally purged from the process, either with or without additional processing, is herein called DMT process residue.

Polyoxyalkylene polyether polyols, which can be obtained by known methods, are preferred for use as the additional polyhydroxyl compounds. For example, polyether polyols can be produced by anionic polymerization with alkali hydroxides such as sodium hydroxide or potassium hydroxide or alkali alcoholates, such as sodium methylate, sodium ethylate, or potassium ethylate or potassium isopropylate as catalysts and with the addition of at least one initiator molecule containing 2 to 8, preferably 3 to 8, reactive hydrogens or by cationic polymerization with Lewis acids such as antimony pentachloride, boron trifluoride etherate, etc., or bleaching earth as catalysts from one or more alkylene oxides with 2 to 4 carbons in the alkylene radical. Any suitable alkylene oxide may be used such as 1,3-propylene oxide, 1,2-and 2,3-butylene oxide, amylene oxides, styrene oxide, and preferably ethylene oxide and 1,2-propylene oxide and mixtures of these oxides. The polyalkylene polyether polyols may be prepared from other starting materials such as tetrahydrofuran and alkylene oxide-tetrahydrofuran mixtures; epihalohydrins such as epichlorohydrin; as well as aralkylene oxides such as styrene oxide. The polyalkylene polyether polyols may have either primary or secondary hydroxyl groups.

Included among the polyether polyols are polyoxyethylene glycol, polyoxypropylene glycol, polyoxybutylene glycol, polytetramethylene glycol, block copolymers, for example, combinations of polyoxypropylene and polyoxyethylene glycols, poly-1,2-oxybutylene and polyoxyethylene glycols, poly-1,4-tetramethylene and polyoxyethylene glycols, and copolymer glycols prepared from blends or sequential addition of two or more alkylene oxides. The polyalkylene polyether polyols may be prepared by any known process such as, for example, the process disclosed by Wurtz in 1859 and Encyclopedia of Chemical Technology, Vol. 7, pp. 257-262, published by Interscience Publishers, Inc. (1951) or in U.S. Pat. No. 1,922,459.

Polyethers which are preferred include the alkylene oxide addition products of polyhydric alcohols such as ethylene glycol, propylene glycol, dipropylene glycol, trimethylene glycol, 1,2-butanediol, 1,5-pentanediol, 1,6-hexanediol, 1,7-heptanediol, hydroquinone, resourcinol glycerol, glycerine, 1,1,1-trimethylol-propane, 1,1,1-trimethylolethane, pentaerythritol, 1,2,6-hexanetriol, a-methyl glucoside, sucrose, and sorbitol. Also included within the term “polyhydric alcohol” are compounds derived from phenol such as 2,2-bis(4-hydroxyphenyl)-propane, commonly known as Bisphenol A.

One preferred additional polyether polyol of the present invention is Voranol® 370, a sucrose based polyether polyol having a hydroxyl number of approximately 370 and commercially produced by the Dow Chemical Company. Other preferred additional polyether polyols are Pluracol® PEP 450 and 550 polyether tetrols having hydroxyl numbers of approximately 560 and 450, respectively and commercially produced by BASF Corporation, and Pluracol® GP 730 that is a polyether triol having a hydroxyl number of approximately 270 and commercially available from BASF Corporation.

Suitable organic amine initiators which may be condensed with alkylene oxides include aromatic amines such as aniline, N-alkylphenylenediamines, 2,4′-,2,2′, and 4,4′-methylenedianiline, 2,6- or 2,4-toluenediamine, vicinal toluenediamines, o-chloro-aniline, paminoaniline, 1,5-diaminonaphthalene, methylene dianiline, the various condensation products of aniline and formaldehyde, and the isomeric diaminotoluenes; and aliphatic amines such as mono-, di-, and trialkanolarnines, ethylene diamine, propylene diamine, diethylenetriamine, methylamine, ethanolamine, diethanolamine, N-methyl- and N-ethylethanolamine, N-methyl- and N-ethyldiethanolamine, triethanolamine, triisopropanolamine, 1,3-diaminopropane, 1,3-diaminobutane, and 1,4-diaminobutane. Preferable amines include polyoxypropylenediamine, such as Jeffamine® D-230 commercially produced by Huntsman Corporation.

It is to be understood that the polyols initiated by an amine can also be initiated with a polyhydric alcohol, such as when a mixed initiator of an aliphatic amine/polyhydric alcohol is used like an amine/sucrose package.

Suitable polyhydric polythioethers which may be condensed with alkylene oxides include the condensation product of thiodiglycol or the reaction product of a dicarboxylic acid such as is disclosed above for the preparation of the hydroxyl-containing polyesters with any other suitable thioether glycol.

The hydroxyl-containing polyester may also be a polyester amide such as is obtained by including some polyester amide such as is obtained by including some amine or amino alcohol in the reactants for the preparation of the polyesters. Thus, polyester amides may be obtained by condensing an amino alcohol such as ethanolamine with the polycarboxylic acids set forth above or they may be made using the same components that make up the hydroxyl-containing polyester with only a portion of the components being a diamine such as ethylene diamine. Suitable polyacetals which may be condensed with alkylene oxides include the reaction product of formaldehyde or other suitable aldehyde with a dihydric alcohol or an alkylene oxide such as those disclosed above.

Suitable aliphatic thiols which may be condensed with alkylene oxides include alkanethiols containing at least two —SH groups such as 1,2-ethanedithiol, 1,2-propanedithiol, 1,2-propanedithiol, and 1,6-hexanedithiol; alkene thiols such as 2-butene-1,4-dithiol; and alkyne thiols such as 3-hexyne-1,6-dithiol.

In one preferred embodiment of the subject invention, the at least one additional polyol is selected from the group of sucrose-initiated polyether polyols, polyether tetrols, polyether triols, and mixtures thereof. The at least one additional polyol is present in an amount of from greater than 0 to 35 parts by weight based on 100 parts by weight of the resin composition.

As discussed above, physical blowing agents are those which boil as the mixture reacts exothermically and forms the polyurethane foam, preferably at 50° C., or less. The most preferred physical blowing agents are those which have a zero ozone depletion potential. Examples of physical blowing agents are the volatile non-halogenated hydrocarbons having two to seven carbon atoms such as alkanes, alkenes, cycloalkanes having up to 6 carbon atoms, dialkyl ether, cycloalkylene ethers and ketones; and hydrofluorocarbons (HFCs).

Examples of volatile non-halogenated hydrocarbons include linear or branched alkanes, e.g. butane, isobutane, 2,3-dimethylbutane,n- and isopentane and technical-grade pentane mixtures, n- and isohexanes, n- and isoheptanes, n- and isooctanes, n- and isononanes, n- and isodecanes, n- and isoundecanes, and n- and isodedecanes. Since very good results are achieved with respect to the stability of emulsions, the processing properties of the reaction mixture and the mechanical properties of polyurethane foam products produced when n-pentane, isopentane or n-hexane, or a mixture thereof is used, these alkanes are preferably employed. Furthermore, specific examples of alkenes are 1-pentene, 2-methylbutene, 3-methylbutene, and 1-hexene; of cycloalkanes are cyclobutane, preferably cyclopentane, cyclohexane or mixtures thereof; specific examples of linear or cyclic ethers are dimethyl ether, diethyl ether, methyl ethyl ether, vinyl methyl ether, vinyl ethyl ether, divinyl ether, tetrahydrofuran and furan; and specific examples of ketones are acetone, methyl ethyl ketone and cyclopentanone. Preferentially, cyclopentane, n- and isopentane, n-hexane, and mixtures thereof are employed.

Suitable hydrofluorocarbons include difluoromethane (HFC-32); 1,1,1,2-tetrafluoroethane (HFC-134a); 1,1,2,2-tetrafluoroethane (HFC-134); 1,1-difluoroethane (HFC-152a); 1,2-difluoroethane (HFC-142), trifluoromethane; heptafluoropropane (R-227a); hexafluoropropane (R-136); 1,1,1-trifluoroethane; 1,1,2-trifluoroethane; fluoroethane (R-161); 1,1,1,2,2-pentafluoropropane; pentafluoropropylene (R-2125a); 1,1,1,3-tetrafluoropropane; tetrafluoropropylene (R-2134a); difluoropropylene (R-2152b); 1,1,2,3,3-pentafluoropropane; 1,1,1,3,3-pentafluoro-n-butane; and 1,1,1,3,3-pentafluoropentane (245fa).

In one preferred embodiment, the physical blowing agent is selected from the group of cyclopentane, isopentane, n-pentane, trans-1,2-dichloroethylene, and mixtures thereof. The physical blowing is present in an amount of greater than 10 parts by weight, preferably greater than 10 to 40 parts by weight, and more preferably greater than 10 to 30 parts by weight, based on 100 parts by weight of the resin composition.

In a most preferred embodiment, the physical blowing agent is cyclopentane. Cyclopentane has a boiling point of 322 K. (49° C. at 760 mm/Hg) and readily vaporizes to froth the mixture as it exits the dispensing gun. The mixture may not froth as it exits the dispensing gun depending on processing temperatures of the mixture. The cyclopentane may be added to the resin composition at the dispensing gun as a separate stream; blended into the resin composition supply vessel immediately prior to dispensing; or it may be pre-blended into the resin composition, stored, and shipped in the pressurized vessel to a manufacturer of the polyurethane foams of the present invention. To make the resin composition by any of these methods, cyclopentane is metered into the resin composition, and, optionally, but preferably, blended until a homogenous solution is formed. In one embodiment the vessel containing the resin composition is pressurized at 150-300 psig, and depending on the type of dispensing method employed as discussed further below, may also be pre-combined with an inert gas such as nitrogen.

The amount of cyclopentane employed will depend upon the desired density of the polyurethane foam and the limits of its solubility in a particular resin composition. However, the related art compositions were limited by the physical blowing agent because the resin composition saturates at a relatively small amount. For example, when the physical blowing agent is R-134a, the resin composition saturates at about 10 parts by weight based on 100 parts by weight of the resin composition. Therefore, in order to ensure that the polyurethane foam has the desired density, additional physical blowing agents or chemical blowing agents had to be used. The subject invention uses the physical blowing agent in an amount greater than 10 parts by weight based on 100 parts by weight of the resin composition, which eliminates the need for additional physical blowing agents or chemical blowing agents. This is particularly advantageous since the chemical blowing agents react with the polyisocyanate and generally requires more polyisocyanate to form the polyurethane foam. Since the subject invention is substantially free of chemical blowing agents, less polyisocyanate is consumed and the cost of producing the polyurethane foam is also reduced.

The resin composition may also include a catalyst system. The catalyst system is selected from at least one of a curing catalyst, a blow catalyst, and a gelation catalyst. The catalyst system may be employed to greatly accelerate the reaction of the compounds containing isocyanate-reactive hydroxyl groups with the modified or unmodified polyisocyanates. Curing catalysts also function to shorten tack time, promote green strength and prevent foam shrinkage. Suitable curing catalysts are organometallic catalysts, preferably organo-lead catalysts, although it is possible to employ metals such as tin, titanium, copper, mercury, cobalt, nickel, iron, vanadium, antimony, bismuth, lithium, and manganese. Preferred curing catalysts. include lead octoate and lead napthanate. The curing catalyst is preferably present in an amount of from 0.01 to 0.9 parts by weight based on 100 parts by weight of the resin composition.

Blow catalysts include tertiary amines and promote urethane linkage formation. Examples of blow catalysts are polyoxypropylenediamines which include triethylamine, 3-methoxypropyldimethylamine, triethylenediamine, tributylamine, dimethylcyclohexylamine, dimethylbenzylamine, N-methyl-, N-ethyl- and N-cyclohexylmorpholine, N,N,N′, N′-tetramethylethylenediamine, NN,N′,N′-tetramethylbutanediamine or-hexanediamine, N,N,N′-trimethyl isopropyl propylenediamine, pentamethyldiethylenetriamine, tetramethyldiaminoethylether, bis(-dimethylaminopropyl)urea, dimethylpiperazine, 1-methyl-4-dimethylaminoethylpiperazine, 1,2-dimethylimidazole, 1-azabicylo[3.3.0]octane and preferably 1,4-diazabicylo[2.2.2]octane, and alkanolamine compounds, such as triethanolamine, triisopropanolamine, N-methyl- and N-ethyldiethanolamine and dimethylethanolamine.

Another type of blow catalysts is tertiary amine ether catalysts. Typical tertiary amine ether blow catalysts include, but are not limited to, N,N,N,N″-tetramethyl-2,2′-diaminodiethyl ether; 2-dimenthyaminoethyl-1,3-dimenthylamineo-propyl ether; and N,N-dimorpholinoethyl ether. Most preferred is pentamethyldiethylenetriamine. The blow catalyst is preferably present in an amount of from 0.01 to 3 parts by weight based on 100 parts by weight of the resin composition.

The blow catalyst can be used in its pure form or dissolved in a carrier such as a glycol. When the catalyst system is dissolved in a carrier, the amounts stated herein as parts by weight refers to the amount of catalyst system and does not include the weight of the carrier.

Preferably, the catalyst system of the present invention includes at least one cure catalyst and at least one blow catalyst described above. More preferably, the catalyst system also includes the gelation catalyst, such as triethylenediamine in a dipropylene glycol carrier, which is commercially produced under the trade name Dabco® LV-33 by the Air Products Corporation. The gelation catalyst is preferably present in an amount of from 0.01 to 3 parts by weight based on 100 parts by weight of the resin composition.

The resin composition may also include a flame retardant. The flame retardant is preferably present in an amount of from 5 to 25 parts by weight based on 100 parts by weight of the resin composition. Examples of suitable flame retardants are tricresyl phosphate, tris(2-chloroethyl) phosphate, tris(2-chloropropyl) phosphate, and tris(2,3-dibromopropyl) phosphate. Yet another suitable flame retardant is PHT 4 Diol, Tetrabromophthalic Acid, commercially available from Great Lakes Chemical Company. In addition to these halogen-substituted phosphates, it is also possible to use inorganic or organic flame retardants, such as red phosphorous, aluminum oxide hydrate, antimony trioxide, arsenic oxide, ammonium polyphosphate (Exolit®) and calcium sulfate, molybdenum trioxide, ammonium molybdate, ammonium phosphate, pentabromodiphenyloxide, 2,3-dibromopropanol, hexabromocyclododecane, dibromoethyldibromocyclohexane, expandable graphite or cyanuric acid derivatives, e.g., melamine, or mixtures of two or more flame retarding agents, e.g., ammonium polyphosphates and melamine, and, if desired, corn starch, or ammonium polyphosphate, melamine, and expandable graphite and/or, if desired, aromatic polyesters, in order to flame retard the polyisocyanate polyaddition products.

A surfactant may also be included in the resin composition and the surfactant is preferably present in an amount of from 0.01 to 5.0 parts by weight based on 100 parts by weight of the resin composition. Examples of suitable surfactants that may be used are compounds which serve to support homogenization of the starting materials and may also regulate the cell structure of the polyurethane foam. Specific examples are salts of sulfonic acids, e.g., alkali metal salts or ammonium salts of fatty acids such as oleic or stearic acid, of dodecylbenzene- or dinaphthylmethanedisulfonic acid, and ricinoleic acid; foam stabilizers, such as siloxaneoxyalkylene copolymers and other organopolysiloxanes, oxyethylated alkyl-phenols, oxyethylated fatty alcohols, pariffin oils, castor oil esters, ricinoleic acid esters, Turkey red oil and groundnut oil, and cell regulators, such as paraffins, fatty alcohols, and dimethylpolysiloxanes. A particularly preferred non-silicone surfactant is LK-443 commercially produced by Air Products Corporation.

The polyisocyanate that may be used in the present invention includes all essentially known aliphatic, cycloaliphatic, araliphatic and preferably aromatic multivalent isocyanates. Specific examples include: alkylene diisocyanates with 4 to 12 carbons in the alkylene radical such as 1,12-dodecane diisocyanate, 2-ethyl-1,4-tetramethylene diisocyanate, 2-methyl-1,5-pentamethylene diisocyanate, 1,4-tetramethylene diisocyanate and preferably 1,6-hexamethylene diisocyanate; cycloaliphatic diisocyanates such as 1,3- and 1,4-cyclohexane diisocyanate as well as any mixtures of these isomers, 1-isocyanato-3,3,5-trimethyl-5-isocyanatomethylcyclohexane (isophorone diisocyanate), 2,4- and 2,6-hexahydrotoluene diisocyanate as well as the corresponding isomeric mixtures 4,4′, 2,2′- and 2,4′-dicyclohexylmethane diisocyanate as well as the corresponding isomeric mixtures and preferably aromatic diisocyanates and polyisocyanates such as 2,4- and 2,6-toluene diisocyanate and the corresponding isomeric mixtures 4,4′-, 2,4′-and 2,2′-diphenylmethane diisocyanate and the corresponding isomeric mixtures, mixtures of 4,4′- and 2,4′-diphenylmethane diisocyanates and polyphenylenepolymethylene polyisocyanates (polymeric MDI), as well as mixtures of polymeric MDI and toluene diisocyanates.

Frequently, the polyisocyanate may include so-called modified multivalent isocyanates, i.e., products obtained by the partial chemical reaction of organic diisocyanates and/or polyisocyanates are used. Examples include diisocyanates and/or polyisocyanates containing ester groups, urea groups, biuret groups, allophanate groups, carbodiimide groups, isocyanurate groups, and/or urethane groups. Specific examples include organic, preferably aromatic, polyisocyanates containing urethane groups and having an NCO content of 15 to 33.6 parts by weight, preferably 21 to 32 parts by weight, based on 100 parts by weight, e.g., with low molecular weight diols, triols, dialkylene glycols, trialkylene glycols, or polyoxyalkylene glycols with a molecular weight of up to 1500; modified 4,4′-diphenylmethane diisocyanate or 2,4- and 2,6-toluene diisocyanate, where examples of di- and polyoxyalkylene glycols that may be used individually or as mixtures include diethylene glycol, dipropylene glycol, polyoxyethylene glycol, polyoxypropylene glycol, polyoxyethylene glycol, polyoxypropylene glycol, and polyoxypropylene polyoxyethylene glycols or -triols. Prepolymers containing NCO groups with an NCO content of 9 to 25 parts by weight, preferably 14 to 21 parts by weight, based on 100 parts by weight and produced from the polyester polyols and/or preferably polyether polyols described below; 4,4′-diphenylmethane diisocyanate, mixtures of 2,4′- and 4,4′-diphenylmethane diisocyanate, 2,4,-and/or 2,6-toluene diisocyanates or polymeric MDI are also suitable. Furthermore, liquid polyisocyanates containing carbodiimide groups having an NCO content of 15 to 33.6 parts by weight, preferably 21 to 32 parts by weight, based on 100 parts by weight, have also proven suitable, e.g., based on 4,4′- and 2,4′- and/or 2,2′-diphenylmethane diisocyanate and/or 2,4′- and/or 2,6-toluene diisocyanate. The modified polyisocyanates may optionally be mixed together or mixed with unmodified organic polyisocyanates such as 2,4′- and 4,4′-diphenylmethane diisocyanate, polymeric MDI, 2,4′- and/or 2,6-toluene diisocyanate.

Organic polyisocyanates which may be employed include aromatic, aliphatic, and cycloaliphatic polyisocyanates and combinations thereof. Representative of these types are the diisocyanates such as m-phenylene diisocyanate, 2,4-toluene diisocyanate, 2,6-toluene diisocyanate, mixtures of 2,4- and 2,6-toluene diisocyanate, hexamethylene diisocyanate, tetramethylene diisocyanate, cyclohexane-1,4-diisocyanate, hexahydrotoluene diisocyanate (and isomers), naphthalene-1,5-diisocyanate, 1-methoxyphenyl-2,4-diisocyanate, 4,4′-diphenylmethane diisocyanate, mixtures of 4,4′- and 2,4′-diphenylmethane diisocyanate, 4,4′-biphenylene diisocyanate, 3,3′-dimethoxy-4,4′-biphenyl diisocyanate, 3,3′-dimethyl-4,4′-biphenyl diisocyanate and 3,3′-dimethyldiphenylmethant-4,4′-diisocyanate; the triisocyanates such as 4,4′, 4″-triphenylmethane triisocyanate, and toluene 2,4,6-trisocyanate; and the tetraisocyanates such as 4,4′- dimethldiphenylmethane-2,2′, 5,5′-tetraisocyanate and polymeric polyisocyanates such as polymethylene polyphenylene polyisocyanate, and mixtures thereof. Especially useful due to their availability and properties are 4,4′-diphenylmethane diisocyanate, polymethylene polyphenylene polyisocyanate, or mixtures thereof for rigid foams, or a mixture of the foregoing with toluene diisocyanates for semi-rigid foams.

Crude polyisocyanates may also be used in the compositions of the present invention, such as crude toluene diisocyanate obtained by the phosgenation of a mixture of toluenediamines or crude diphenylmethane isocyanate obtained by the phosgenation of crude isocyanates as disclosed in U.S. Pat. No. 3,215,652.

In a preferred embodiment, the froth spraying system includes a resin supply vessel, a polyisocyanate supply vessel, a spray machine, and a dispensing gun having a mixing chamber. Each of the supply vessels may be pressured as understood by those skilled in the art. The resin composition is provided in a stream from the resin supply vessel to the spray machine and from the spray machine to the dispensing gun. The resin composition is provided separate from the isocyanate, such that the isocyanate is also provided in a stream from the polyisocyanate supply vessel to the spray machine and from the spray machine to the dispensing gun.

The spraying system according to the subject invention monitors flammable gas levels to detect leaks in the stream of the resin composition. In order to monitor these gas levels, the supply vessel for the resin composition is located in a storage room, which also contains the spray machine and the hoses, and is isolated from an area to be sprayed. This area would be classified for Class 1, Zone 2, Group D. The storage room also typically includes the spray machine. The spray machine is preferably a fixed proportioner machine with two positive displacement pumps, one for the isocyanate and the other for the resin. The spray machine heats the two liquid components up to the desired temperature (typically between 26-66° C.), pressurizes the components (typically between 4000-20,400 kPa), then delivers them through separate hoses to the spray gun with the mixing head. A spray operator sprays the foam onto the desired substrate, such as a concrete wall, OSB, etc. Typical manufacturers of spray machines are Gusmer Inc, Graco Inc, and Glas-Craft.

The storage room is also isolated from an operation chamber. The operation chamber houses electrical components that operate the spraying system, such as a generator, a compressor, and/or an electrical panel. It is important that the operation chamber be sealed from the storage room incase of a leak in the system of flammable gas because any sparks generated in the electrical components may ignite an explosion.

In operation, a truck would have each of these areas located in a truck box. Since these areas are separated, the entire truck box does not need to be explosion proof, only the area storing the supply vessels needs to be explosion proof. The cost to produce the polyurethane foam is significantly reduced if only a portion of the truck bed needs to be explosion proof because this reduces the cost of the equipment required to spray the materials.

The subject invention monitors the flammable gas level by positioning sensors in the storage room near the spray machine and the supply vessels. When the flammable gas levels are detected above a predetermined threshold, then the froth spraying system is deactivated. Preferably, the froth spraying system is deactivated when the level of flammable gas reaches 20%. Additionally, an alarm may be activated to alert the user of increased flammable gas levels when it reaches 10%. Additionally, a sensor on the user monitors the flammable gas levels at the area where the polyurethane foam is being sprayed to alert the user of flammable gas levels in the spray area.

If the flammable gas levels are detected in the storage room, after deactivating the froth spraying system, the storage room is vented to reduce the flammable gas levels therein. At least one fan is located within the storage room to draw out the flammable gas. The froth spraying system is re-activated in response to the flammable gas levels dropping below the predetermined threshold. Likewise, if the flammable gas levels at the area to be sprayed are above the predetermined threshold, the operator is notified. The area to be sprayed, if properly ventilated, may include enclosed areas such as, but not limited to, crawl spaces and the like.

The spray froth system also includes at least one reactant supply tank for imposing gas pressure to drive the reactants from the supply vessels and a fixed ratio positive displacement pump, specifically designed for the spray application of polyurethane foams. Any means for imposing pressure to drive the reactants from the supply vessels may be used. Typically, a pressurized gaseous inert propellant, such as a nitrogen tank, is used having valved outlets communicating via suitable conduits with the inlets to the supply vessels. The supply vessels are kept under pressure to provide the driving force needed to propel the reactants from the supply vessels. The pressure in the pressurized supply vessels is generally 150-300 psig. However, pressure may be as low as 50 psig without using an additional pump. If an additional pump is used to withdraw the component from the vessel, then pressure may be as low as 0.5 psig to act as a positive pressure and to prevent a vacuum from occurring in the vessel.

It is generally necessary, for the proper functioning of the spray froth system, that the viscosity of the contents of each of the supply vessels be no greater than about 1200 cps at 25° C. And more preferably no more than about 800 cps. This, of course, means that the materials in each tank may have to be properly selected or formulated, as the case may be, in order to meet this viscosity requirement. The viscosity values mentioned herein are measured at 25° C. and at 80 psig (544 psi).

By using the fixed ratio, positive displacement pump, specifically designed for the spray application of polyurethane foams, the volume ratio of the isocyanate stream and the resin composition stream can be held at 1:1.

### EXAMPLES

The following examples are intended to illustrate, but in no way limit, the scope of the present invention. The spray froth system used in this example comprised: (a) a first supply vessel for supplying the isocyanate reactant, (b) a second supply vessel for supplying the resin composition, (c) a nitrogen pressure tank having a valved outlet in communication, via a distributing valve, with inlets to the two supply vessels, and (d) a fixed ratio positive displacement pump, (e) and LEL detector (lower explosion limit) commercially available from BW Technologies and Dräger.

The components forming the resin composition are listed Table 1, below, and are in parts by weight, unless other indicated.

TABLE 1
Resin Composition

| Components | Example 1 | Example 2 |
|---|---|---|
| Mannich Polyol | 27.82 | 32.72 |
| Additional Polyol | 29.02 | 31.00 |
| Surfactant | 1.50 | — |
| Catalyst A | 0.27 | — |
| Catalyst B | 0.09 | — |
| Catalyst C | — | 0.50 |
| Catalyst D | — | 0.18 |
| Physical Blowing Agent | 20.00 | 15.00 |
| Chemical Blowing Agent | 0.30 | 0.6 |
| Flame Retardant | 20.00 | 10.00 |
| FR Agent | — | 10.00 |
| Cross-linker A | 1.00 | — |
| Total | 100.00 | 100.00 |

The Mannich polyol is Mannich-based and has a functionality of about 4 and a hydroxyl number of about 470. The Mannich polyol is commercially available as Thanol® R470X from Dow Chemical. The additional polyol is an ethylene diamine based polyether polyol having a hydroxyl number of about 800 and a functionality of about 4. The additional polyol is commercially available as Jeffol® R290 from Huntsman Petrochemical.

The surfactant is a non-silicone, organic surfactant commercially available as LK-221® from Air Products and Chemicals. Catalyst A is a low-viscosity liquid amine catalyst that is blend of 20% triethylenediamine and 80% dimethylethanolamine. Catalyst A is an amine based catalyst commercially available as DABCO® R-8020 from Air Products and Chemicals. Catalyst B is lead octoate having about 24% lead. Catalyst C is an amine based catalyst commerically available from Toyocat as RX-5.

The physical blowing agent is cyclopentane having a boiling point of about 49° C., commercially available as EXXOL™ HP-95 from Exxon Mobil Chemcial. The chemical blowing agent is water. The flame retardant is tris-(chloroisopropyl) phosphate. The cross-linker A is glycerine having a functionality of three. FR agent acts as a fire retardant and is an aromatic polyester polyol having a functionality of about 2 and hydroxyl number of about 305 mg KOH/g commercially available from Invista as Terate® 4020.

The resin composition of Table 1 was sprayed in a 1:1 volumetric ratio with a polyisocyanate through the spray froth system described above. The polyisocyanate is polyphenylenepolymethylene polyisocyanates (polymeric MDI) commercially available as Lupranate M20S from BASF Corp. The resin composition and the polyisocyanate reacted to form the polyurethane foam.

Table 2 below lists the physical properties for a sample of the resultant polyurethane foam having the dimensions 1″×4″×4″. The sample was tested in accordance ASTM D 1622-98 “Standard Test Method for Apparent Density of Rigid Cellular Plastics”, ASTM D 1621-00 “Standard Test Method for Compressive Properties of Rigid Cellular Plastics” Procedure A, ASTM C 518-98 “Standard Test Method for Steady-State Thermal Transmission Properties by Means of the Heat Flow Meter Apparatus”, ASTM D 2126-99 “Standard Test Method for Response of Rigid Cellular Plastics to Thermal and Humid Aging”, ASTM E 96-00 “Standard Test Method for Water Vapor Transmission & Materials,” Procedure A, ASTM D 6226-98 “Standard test method for Open Cell Content of Rigid Cellular Plastics” and ASTM D 2842-97 “Standard Test Method for Water Absorption of Rigid Cellular Plastics”.

TABLE 2
Physical Properties of Polyurethane Foam

| Property | Example 1 | Example 2 |
|---|---|---|
| Density (pcf) | 1.83 | 1.97 |
| Initial K Factor (W/mk) | 0.02159 | 0.02107 |
| Compressive Strength | 20.73 | 28.00 |
| @ 10% (psi) | | |
| Water Absorption (%) | 0.83 | N/A |
| Closed Cell (%) | 85.17 | N/A |
| Water Vapor | 102.00 | N/A |
| Permeance | | |
| (mg/Pas m²) − 1″ Core | | |
| Water Vapor | 61.20 | N/A |
| Permeance | | |
| (mg/Pas m²) − 1″ Skin | | |

The polyurethane foam sample also underwent dimensional stability analysis. Table 3 illustrates the results of the dimensional stability analysis listed in % volume change.

TABLE 3
Dimensional Stability Analysis

| Time/Temp | Example 1 | Example 2 |
|---|---|---|
| 24 Hours | 0.55 | 1.10 |
| 80° C. | | |
| 7 Days | 3.12 | 2.32 |
| 80° C. | | |
| 14 Days | 3.80 | 3.08 |
| 80° C. | | |
| 28 Days | 5.14 | N/A |
| 80° C. | | |

The polyurethane foams formed according to the subject invention have a satisfactory dimensional stability. After 24 hours at 80° C., Example 1 had 0.55% volume change and Example 2 had 1.10% volume change, both measured from the original sample volume. After 7 days at 80° C., Example 1 had 3.12% volume change and Example 2 had 2.32% volume change, both measured from the original sample volume.

Obviously, many modifications and variations of the present invention are possible in light of the above teachings. The invention may be practiced otherwise than as specifically described within the scope of the appended claims.

In the claims:

1. A resin composition for use in a froth spraying system for forming polyurethane foam, said resin composition comprising:
a Mannich polyol having a viscosity of at least 4,000 centipoise at 25° C.;
at least one additional polyol other than a Mannich polyol; and
a physical blowing agent selected from the group consisting of volatile non-halogenated C₂ to C₇ hydrocarbons, hydrofluorocarbons, hydrochlorocarbons, and mixtures thereof and present in an amount of greater than 10 parts by weight based on 100 parts by weight of said resin composition.

2. A resin composition as set forth in claim 1 wherein said resin composition is substantially free of chemical blowing agents.

3. A resin composition as set forth in claim 2 wherein said physical blowing agent is selected from the group consisting of cyclopentane, isopentane, n-pentane, trans-1,2-dichloroethylene, and mixtures thereof.

4. A resin composition as set forth in claim 1 wherein said physical blowing agent is present in an amount of from greater than 10 to 40 parts by weight based on 100 parts by weight of said resin composition.

5. A resin composition as set forth in claim 1 wherein said resin composition has a hydroxyl content of at least 400 mg KOH/g.

6. A resin composition as set forth in claim 1 further comprising a flame retardant present in an amount of from 5 to 25 parts by weight based on 100 parts by weight of said resin composition.

7. A resin composition as set forth in claim 1 wherein said Mannich polyol comprises an aromatic, amino polyol having a hydroxyl content of at least 400 mg KOH/g.

8. A resin composition as set forth in claim 7 wherein said Mannich polyol comprises an aromatic, amino polyol having an amino content of at least 2.8 meq/g.

9. A resin composition as set forth in claim 7 wherein said Mannich polyol is present in an amount of from 20 to 40 parts by weight based on 100 parts by weight of said resin composition.

10. A resin composition as set forth in claim 1 wherein said at least one additional polyol is selected from the group consisting of a sucrose-initiated polyether polyol, a polyether tetrol, a polyether triol, and mixtures thereof.

11. A resin composition as set forth in claim 1 wherein said at least one additional polyol is present in an amount of from greater than 0 to 35 parts by weight based on 100 parts by weight of said resin composition.

12. A resin composition as set forth in claim 1 further comprising a catalyst system selected from at least one of a curing catalyst, a blow catalyst, and a gelation catalyst.

13. A resin composition as set forth in claim 12 wherein said curing catalyst comprises lead octoate present in an amount of from 0.01 to 0.9 parts by weight based on 100 parts by weight of said resin composition.

14. A resin composition as set forth in claim 12 wherein said blow catalyst comprises one of pentamethyldiethylenetriamine or polyoxypropylenediamine and the blow catalyst is present in an amount of from 0.01 to 3 parts by weight based on 100 parts by weight of said resin composition.

15. A resin composition as set forth in claim 12 wherein said gelation catalyst comprises triethylenediamine in a dipropylene glycol carrier and the gelation catalyst is present in an amount of from 0.01 to 3 parts by weight based on 100 parts by weight of said resin composition.

16. A resin composition as set forth in claim 1 further comprising a surfactant present in an amount of from 0.01 to 5.0 parts by weight based on 100 parts by weight of said resin composition.

17. A method of forming a polyurethane foam using a froth spraying system including supply vessels, a spray machine, and a dispensing gun having a mixing chamber, said method comprising the steps of:
providing a resin composition comprising a Mannich polyol having a viscosity of at least 4,000 centipoise at 25° C., at least one additional polyol other than a Mannich polyol, and a physical blowing agent selected from the group consisting of volatile non-halogenated C₂ to C₇ hydrocarbons, hydrofluorocarbons, hydrochlorocarbons, and mixtures thereof and used in an amount of greater than 10 parts by weight based on 100 parts by weight of the resin composition;
providing a polyisocyanate;
mixing the resin composition with the polyisocyanate in the mixing chamber to form a mixture; and
discharging the mixture from the dispensing gun as the resin composition reacts with the polyisocyanate to form the polyurethane foam.

18. A method as set forth in claim 17 wherein the physical blowing agent is selected from the group consisting of cyclopentane, isopentane, n-pentane, trans-1,2-dichloroethylene, and mixtures thereof.

19. A method as set forth in claim 17 wherein the physical blowing agent is used in an amount of from 10 to 40 parts by weight based on 100 parts by weight of the resin composition.

20. A method as set forth in claim 17 wherein the resin composition has a hydroxyl content of at least 400 mg KOH/g.

21. A method as set forth in claim 17 wherein the Mannich polyol is used in an amount of from 20 to 40 parts by weight based on 100 parts by weight of the resin composition.

22. A method as set forth in claim 17 wherein the at least one additional polyol is selected from the group consisting of a sucrose-initiated polyether polyol, a polyether tetrol, a polyether triol, and mixtures thereof.

23. A method as set forth in claim 17 wherein the at least one additional polyol is used in an amount of from greater than 0 to 30 parts by weight based on 100 parts by weight of the resin composition.

24. A method as set forth in claim 17 further comprising the step of providing the resin composition in a stream from a resin supply vessel to the spray machine and from the spray machine to the dispensing gun.

25. A method as set froth in claim 24 wherein the step of providing the resin composition is further defined as providing the resin composition separate from the isocyanate.

26. A method as set forth in claim 24 further comprising the step of monitoring flammable gas levels to detect leaks in the stream of the resin composition.

27. A method as set forth in claim 26 further comprising the step of deactivating the froth spraying system in response to detecting flammable gas levels above a predetermined threshold.

28. A method as set forth in claim 24 further comprising the step of storing the supply vessel for the resin composition in a storage room isolated from an area to be sprayed and isolated from an operation chamber housing electrical components.

29. A method as set forth in claim 28 further comprising the step of monitoring flammable gas levels within the storage room and deactivating the froth spraying system in response to detecting flammable gas levels above a predetermined threshold within the storage room.

30. A method as set forth in claim 29 further comprising the step of venting the storage room to reduce the flammable gas levels therein.

31. A method as set forth in claim 30 further comprising the step of reactivating the froth spraying system in response to the flammable gas levels dropping below the predetermined threshold.

32. A method as set forth in claim 28 further comprising the step of monitoring flammable gas levels at the area to be sprayed and alarming the operator in response to detecting flammable gas levels above a predetermined threshold at the area to be sprayed.
